(19) United States
(12) Patent Application Publication
(10) Pub. No.: US 2007/0258415 A1
(43) Pub. Date: Nov. 8, 2007

(54) HANDSHAKE METHOD FOR WIRELESS CLIENT

(75) Inventors: Kuen-Ruey Lu, Hsinchu City (TW); Bor-Wen Yang, Sijhih City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Accton Technology Corporation

(21) Appl. No.: 11/381,191

(22) Filed: May 2, 2006

(51) Int. Cl. H04Q 7/24

(52) U.S. Cl. 370/338

(57) ABSTRACT

A method for the wireless client automatically updates the security setting of its own in order to access the specified wireless local area network (LAN) by the wireless server. The method comprises several processes, including a wireless client trying to build a wireless connection with a wireless server of the wireless LAN. But the wireless connection fails to be built, because the security setting of the wireless client do not match with the security setting of the wireless server of the wireless LAN. Then the wireless server of the wireless LAN builds a temporary connection with the wireless client in order to communicate with each other. The wireless server of the wireless LAN sends the security setting of the wireless LAN to the wireless client through the temporary connection by HTTP (Hyper Text Transfer Protocol) packets. After the wireless client receives the security settings of the wireless LAN, the wireless client changes the security settings of its own to match the received settings. Because the settings of the wireless client and the wireless server now are synchronized, the wireless client can access the wireless LAN safely and smoothly.

### FIELD OF THE INVENTION

The present invention relates to a method for configurations of wireless network, and more particularly relates to a method for configuring security policies of wireless network.

### BACKGROUND OF THE INVENTION

Local area network (LAN) environment is the most important application in modern personal computer technology. It connects all neighbor computers, and lets them sharing with each other. The experiences and the processes of using the computer become more entertaining than them ever been Although it has so many benefits, the popularity of the LAN environment still grows in a lingering pace. Because the entry barrier of building a personal LAN in home so far is high, it costs many times and much money. Though, the price of the networking equipments is cheaper than ever, the domain knowledge of building a LAN environment does not seem as a common sense.

Besides traditional LAN environment is built in a wired manner, there are lots of wires that need to be arranged in order. The twisted wires always bother the users who want to build a personal LAN environment by their own, and it takes scare efforts to take care the wires in order to build a network environment neatly. After the introduction of the wireless network technologies is making, the nightmare of users seems to be ended. No more twisted wires need to be cleaned, and no more getting down your knees for wiring jobs. But the protection becomes weaker, there are without the physical wires. Hackers can try to intercept the signals that are transferred by the radio frequency, and analyzing the intercepted signals in order to get users' personal information. For the purpose of network security, there are various security procedures in the wireless network protocol. By invoking the selected security procedures in the network equipments, it can ensure that the data leaking will not happen in this wireless LAN.

It seems that all problems have been solved, but actually it makes that the compatibility of the wireless network environment is extremely low due to higher security settings. When a confidential user tries to setup his client device with the wireless network, he may need to consult with the network administrator even he is a “confidential user.” It is very inefficient and too complicated, moreover it needs a lot of human resources to maintain the security procedures and help users to setup their own client manually.

On the other hand, if the user wants to access this wireless LAN, one needs to change his wireless client device's setting in order to pass all security procedures. Under current structure, the user needs to consult with the administrators of the wireless LAN in order to know exactly what the security settings are. Otherwise, the user has to try and try again to change the setting for accessing the network. The user loses his patient after many time of failure.

Thus, a brand new method allows the user to setup the setting without any trouble is required. It is urgent to have some methods that can help user configuring his client easily and quickly.

### SUMMARY OF THE INVENTION

In view of all foregoing drawbacks, the present invention discloses a method for wireless client. When a user with his wireless client devices comes into a new wireless local area network (LAN) environment, he may find out that the setting of his wireless client device are incompatible with the setting in this wireless LAN. If he wants to access this wireless LAN, he needs to change his wireless client device's setting in order to pass all security procedures. Before he achieves all his needs, he needs to consult with the administrators of the wireless LAN in order to know exactly what the security settings are under the scheme of prior art. Then he or the administrators change the setting of the user's wireless client device manually.

The present invention provides a brand new method to allow the user to setup the setting, followed by coupling to the network without asking for someone for help. In accordance with a preferred embodiment of the present invention, there is provided a handshake method for wireless client, comprising trying to build a wireless connection by a wireless client with a wireless server of the wireless LAN. But the wireless connection fails to be built, because the security setting of the wireless client does not match with the security setting of the wireless server of the wireless LAN. Then the wireless server of the wireless LAN builds a temporary connection with the wireless client in order to communicate with each other. The wireless server of the wireless LAN sends the security setting of the wireless LAN to the wireless client through the temporary connection by HTTP (Hyper Text Transfer Protocol) packets. After the wireless client receives the security settings of the wireless LAN, the wireless client changes the security settings of its own to match the received settings. Because the settings of the wireless client and the wireless server now are synchronized, the wireless client can access the wireless LAN safely and smoothly.

According to the aspect of the present invention, the method of a handshake method for wireless client comprising: building a wireless connection with a access point by a wireless client's request; building a temporary connection by the access point; performing DHCP negotiation in bi-direction; filtering packets from the wireless client except HTTP packets by the access point; sending HTTP packets to the access point by the wireless; sending a security policy page to the wireless client; and establishing a connection via the security policy page provided by the access point.

The connection mode of the access point comprises an infrastructure mode and an Ad-hoc mode. The process of building the temporary connection can be done by a DHCP (Dynamic Host Configuration Protocol) negotiation when the wireless client does not have an IP (internet protocol) address.

The process of building the temporary connection further comprises: starting the DHCP negotiation between the wireless client and the access point in bi-direction; and providing a private IP address to the wireless client by the access point.

In accordance with another aspect of the present invention, the present invention is providing a handshake method for a wireless client, and the handshake method comprises following steps: building a wireless connection with a wireless server by the wireless client's request; building a temporary connection with the wireless client by the wireless server when the wireless connection is failed due to first security settings of the wireless client; sending second security settings to the wireless client through the temporary connection by the wireless server; and changing the first security settings to match the second security settings by the wireless client. Furthermore, the first security settings and the second security settings comprise several wireless network security policy parameters. For example, the first security settings and the second security settings can be the security key values, the encryption methods and the 802.11 authentications.

### BRIEF DESCRIPTION OF THE DRAWINGS

FIG. 1 is a flow chart, which illustrates processes of the present invention.

FIG. 2 is a flow chart, which illustrates detail steps of the present invention.

### DETAILED DESCRIPTION OF THE PREFERRED EMBODIMENT

The present invention is described with preferred embodiments and accompanying drawings. It should be appreciated that all the embodiments are merely used for illustration. Although the present invention has been described in term of a preferred embodiment, the invention is not limited to this embodiment. It will be understood, however, to one skilled in the art, that the present invention may be practiced without some or all of these specific details. In other instances, well known process operations have not been described in detail in order not to unnecessary obscure the present invention.

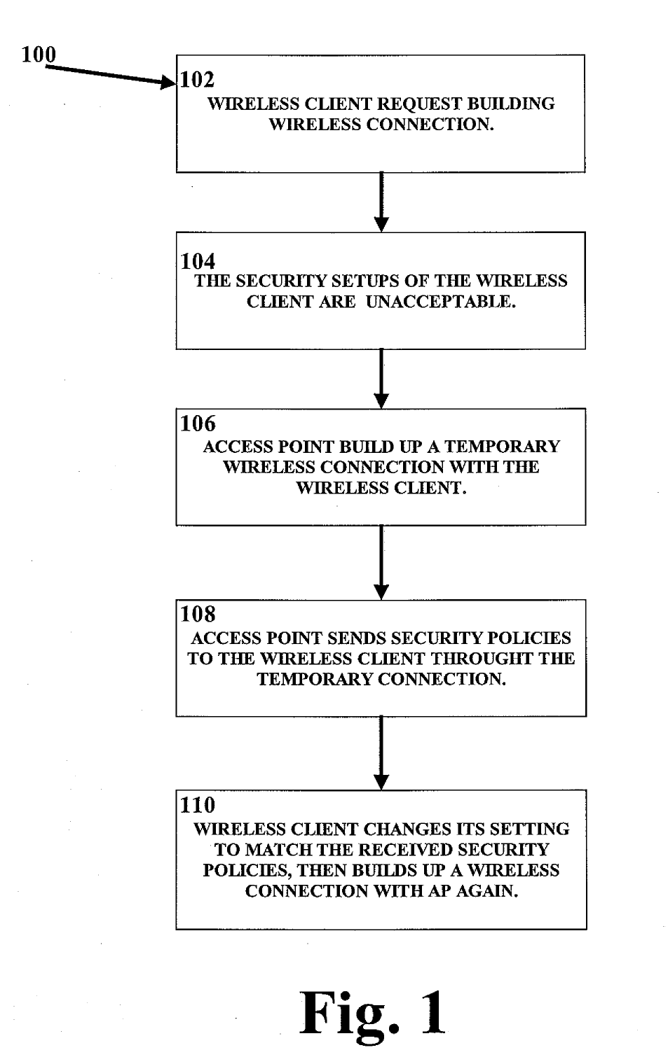

Referring to the FIG. 1 of the present invention is a flow chart illustrating the processes of the handshake method 100 for wireless client. The method 100 includes several steps, first with the process 102, wireless client request building wireless connection, wherein a wireless client tries to build a wireless connection with a wireless server of a wireless local area network (LAN.) The wireless client may be a personal computer, a personal digital assistant device, a mobile phone, a laptop computer or the like. The wireless connection which the wireless client attempted to build is the IEEE 802.11a, IEEE 802.11b, IEEE 802.11g, IEEE 802.11i or the like.

Then at the process 104, the security setup of the wireless client are unacceptable, the wireless server of the wireless LAN rejects the request from the wireless client due to the mismatching between the security setting of the wireless client and the wireless server. Maybe the wireless client actually is a confidential client of the wireless LAN or a normal user who is not familiar with the setting of wireless LAN. Referring to the process 106, access point build up a temporary wireless connection with the wireless client, the wireless server builds a temporary connection with the wireless client in order to further negotiation. The method of distinguishing whether the wireless client confidential or not can be done by verifying the MAC (Media Access Control) address of the wireless client with the trusted lists that are saved on the wireless server. And the temporary connection between the wireless client and the wireless server can be wireless or wired, it depends on which way is more safe. Besides the wireless server of the wireless LAN is not only an access point (AP) but also can be an Ad-hoc server, in the other words the modes of the wireless server include the infrastructure mode and the ad-hoc mode. The building process of the temporary connection is done by a DHCP (Dynamic Host Configuration Protocol) negotiation when the wireless client does not have an acceptable IP (internet protocol) address of the wireless LAN. The more detail steps of the temporary connection between the wireless client and the wireless server will be described in the latter paragraph.

After the temporary connection is built, the wireless server sends the security settings of current wireless LAN to the wireless client through the temporary connection at the steps 108, wherein the access point sends security policies to the wireless client through the temporary connection. Because the temporary connection is also built in a secure way, it can make sure that the security settings will not leak. The security settings of the current wireless LAN and the wireless client are several different security policy parameters, and the security policy parameters includes security key values, encryption methods, 802.11 authentications and other the likes. Moreover, the encryption methods comprise WEP (Wired Equivalent Privacy,) AES (Advanced Encryption Standard,) DES (Data Encryption Standard) and other the likes. Furthermore, the 802.11 authentications include WPA (Wi-Fi Protected Access,) WPA2 and other the likes. Finally, at process 110, wireless client changes its setting to match the received security policies, then builds up a wireless connection with AP again; the wireless client modifies its security settings with the received security settings, and the wireless server disconnect the temporary connection.

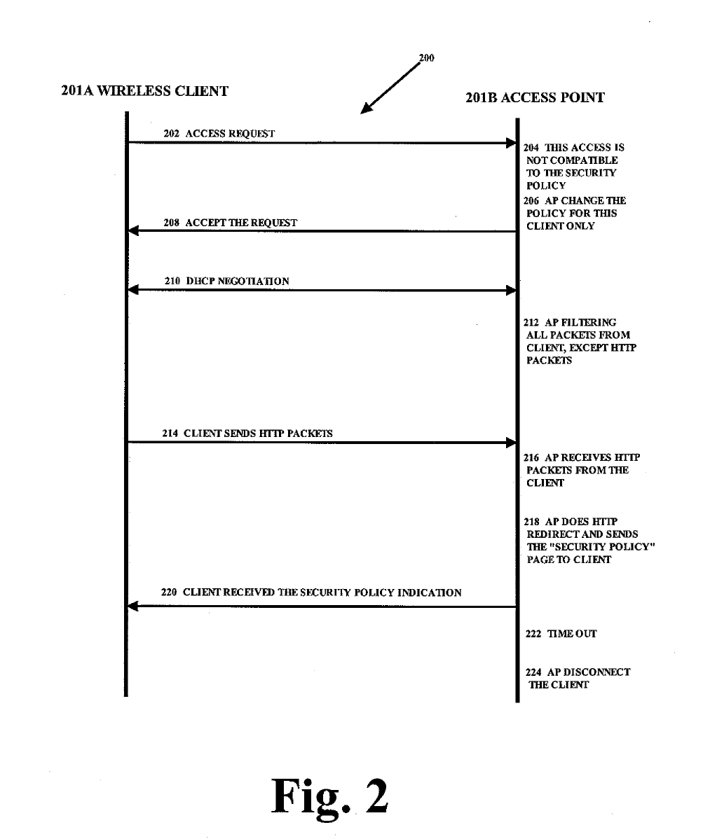

Referring to the FIG. 2 of the present invention is a flow chart illustrating detail steps of the handshake method 200 for wireless client. In this example, there are a wireless client 201A and an access point 201B, but these two devices is merely used for instances not for limiting the present invention.

The method 200 is starting with the process 202, the wireless client 201A make an access request for wireless connection. Then at the process 204 the access point 201B finds that this access request is not compatible to the security policy. The access point 201B changes the policy for this wireless client only at the process 206 for building a temporary connection, and the access point 201B accepts the request for successfully building the temporary connection at process 208. The wireless client 201A and the access point 201B do the DHCP negotiation in bi-direction if the wireless client did not have a legal private IP address, and the access point 201B provides a legal private IP address to the wireless client.

Subsequently, the access point 201B filters all packets from the wireless client 201A except HTTP (Hyper Text Transfer Protocol) packets at the process 212. The wireless client 201A sends HTTP packets to the access point 201B at process 214, and the access point 201B receives the HTTP packets from the wireless client 201A at the process 216. Then the access point 201B does the HTTP redirect and sends the “security policy” page to wireless client 201A, on the other hands the wireless client 201A can receive a web page that lists all security setting of the access point 201B, and the wireless client 201A can use the built in internet browser to view all contents. In the other words, at the process 220 the wireless client 201A will receive the security policy indication. After certain time out at the time interval 222, the access point 201B will disconnect the wireless client 201A in this temporary connection at process 224, and the handshake method 200 is ended.

The present invention provides a brand new method to allow the user to setup the setting by ease and friend way without facing a barrier, followed by coupling to the network without asking for someone for help.

Other embodiments of the invention will be apparent to those skilled in the art from consideration of the specification and practice of the invention. The word “comprising” and forms of the word “comprising” as used in the description and in the claims are not meant to exclude variants or additions to the invention. Furthermore, certain terminology has been used for the purposes of descriptive clarity, and not to limit the present invention. The embodiments and preferred features described above should be considered exemplary, with the invention being defined by the appended claims.

Having described the invention, the following is claimed:

1. A handshake method for a wireless client, said method comprising:
building a wireless connection with a wireless server by said wireless client's request;
building a temporary connection with said wireless client by said wireless server when said wireless connection is failed due to first security settings of said wireless client;
sending second security settings to said wireless client through said temporary connection by said wireless server; and
changing said first security settings to match said second security settings by said wireless client.

2. The method of claim 1, wherein said wireless client comprises a personal computer, a personal digital assistant device, a mobile phone or a laptop computer.

3. The method of claim 1, wherein protocols of said wireless connection comprise IEEE 802.11a, IEEE 802.11b, IEEE 802.11g or IEEE 802.11i.

4. The method of claim 1, wherein said temporary connection comprises a wireless connection or a wired connection.

5. The method of claim 1, wherein a connection mode of said wireless server comprises an infrastructure mode and an Ad-hoc mode.

6. The method of claim 1, wherein said process of building said temporary connection can be done by a DHCP (Dynamic Host Configuration Protocol) negotiation when said wireless client does not have an IP (internet protocol) address.

7. The method of claim 6, wherein said process of building said temporary connection further comprises:
starting said DHCP negotiation between said wireless client and said wireless server in bi-direction; and
providing a private IP address to said wireless client by said wireless server.

8. The method of claim 1, further comprising:
filtering all packets from said wireless client except HTTP (Hyper Text Transfer Protocol) packets by said wireless server.

9. The method of claim 1, wherein said second security settings are sent through HTTP packets to said wireless client by said wireless server.

10. The method of claim 1, wherein said first security settings and said second security settings comprise several wireless network security policy parameters.

11. The method of claim 10, wherein said wireless network security policy parameters of said first security settings comprise security key values, encryption methods and 802.11 authentications.

12. The method of claim 10, wherein said wireless network security policy parameters of said second security settings comprise security key values, encryption methods and 802.11 authentications.

13. The method of claim 11, wherein said encryption methods comprise WEP (Wired Equivalent Privacy,) AES (Advanced Encryption Standard) and DES (Data Encryption Standard.)

14. The method of claim 12, wherein said encryption methods comprise WEP, AES and DES.

15. The method of claim 11, wherein said 802.11 authentications comprise WPA (Wi-Fi Protected Access) and WPA2.

16. The method of claim 12, wherein said 802.11 authentications comprise WPA and WPA2.

17. A handshake method for a wireless client, said method comprising:
building a wireless connection with a access point by said wireless client's request;
building a temporary connection by said access point;
performing DHCP negotiation in bi-direction;
filtering packets from said wireless client except HTTP packets by said access point;
sending HTTP packets to said access point by said wireless;
sendings a security policy page to said wireless client; and
establishing a connection via said security policy page provided by said access point.

18. The method of claim 17, wherein a connection mode of said access point comprises an infrastructure mode and an Ad-hoc mode.

19. The method of claim 17, wherein said process of building said temporary connection can be done by a DHCP negotiation when said wireless client does not have an IP address.

20. The method of claim 19, wherein said process of building said temporary connection further comprises:
starting said DHCP negotiation between said wireless client and said access point in bi-direction; and
providing a private IP address to said wireless client by said access point.

21. The method of claim 1, further comprising:
filtering packets from said wireless client except HTTP packets.

22. The method of claim 17, wherein security settings of said security policy are sent through HTTP packets to said wireless client.

23. The method of claim 22, wherein said security setting comprises security key values, encryption methods and 802.11 authentications.

24. The method of claim 23, wherein said encryption methods comprise WEP, AES and DES.

25. The method of claim 23, wherein said 802.11 authentications comprise WPA and WPA2.
